(19) United States
(12) Patent Application Publication
(10) Pub. No.: US 2020/0169320 A1
(43) Pub. Date: May 28, 2020

(54) OPTICAL TRANSMISSION SYSTEM, OPTICAL TRANSMISSION DEVICE AND NETWORK CONTROL DEVICE

(71) Applicant: FUJITSU LIMITED, Kawasaki-shi (JP)

(72) Inventor: Atsushi Kiyama, Kawasaki (JP)

(73) Assignee: FUJITSU LIMITED, Kawasaki-shi (JP)

(21) Appl. No.: 16/656,994

(22) Filed: Oct. 18, 2019

(30) Foreign Application Priority Data
Nov. 22, 2018 (JP) 2018-218796

(51) Int. Cl. H04B 10/077; H04J 14/02; H04B 10/03

(52) U.S. Cl. CPC H04B 10/0773; H04B 10/0779; H04B 2210/08; H04B 10/03; H04B 2210/078; H04J 14/0278

(57) ABSTRACT

An optical signal is transmitted between first and second transmission devices. When a network control device receives a shutdown report that indicates a loss of light from both of the first and second transmission devices, the network control device transmits a first instruction to resume a transmission of a control signal to both of the first and second transmission devices. When the network control device receives a detection report that indicates a reception of the control signal from both of the first and second transmission devices, the network control device transmits a second instruction to resume a transmission of a WDM signal to both of the first and second transmission devices.

### CROSS-REFERENCE TO RELATED APPLICATION

This application is based upon and claims the benefit of priority of the prior Japanese Patent Application No. 2018-218796, filed on Nov. 22, 2018, the entire contents of which are incorporated herein by reference.

### FIELD

The embodiments discussed herein are related to an optical transmission system, an optical transmission device, a network control device and an optical transmission method.

### BACKGROUND

WDM (Wavelength Division Multiplexing) has become popular for realizing large-volume communications. In WDM, a plurality of channels of different wavelengths are multiplexed. Each node of the WDM transmission system is provided with a ROADM (Reconfigurable Optical Add-Drop Multiplexer). The ROADM is able to branch the optical signal of a desired wavelength from a WDM signal. In addition, the ROADM is able to insert an optical signal into a free channel of a WDM signal. Meanwhile, the WDM signal is transmitted bidirectionally between nodes of the WDM transmission system.

In the WDM transmission system, optical safety control is performed in some cases. For example, a case is assumed in which, in the WDM transmission system illustrated in FIG. 1A, the optical fiber that transmits an optical signal from the ROADM#1 to the ROADM#2 is disconnected from the input port of the ROADM#2. In this case, the user or the maintenance worker may be irradiated with the light output from the optical fiber. Therefore, optical safety control for stopping the WDM signal transmitted from the ROADM#1 (for example, APSD: Automatic Power Shut Down) is performed.

In the case illustrated in FIG. 1A, the receiving power becomes zero at the ROADM#2, and therefore, the ROADM#2 suspends the transmission of the WDM signal by stopping the optical amplifier for amplifying the WDM signal. In addition, the ROADM#2 transmits an APSD request message to the ROADM#1 by inter-node communication using the OSC (Optical Supervisory Channel). Meanwhile, the OSC is a wavelength channel that transmits a supervisory control signal and is arranged outside the wavelength band of the WDM signal. Then, upon receiving the APSD request message, the ROADM#1 suspends the transmission of the WDM signal to the ROADM#2. As a result, the WDM signal is no longer output through the optical fiber.

In recent years, a communication standard called Open ROADM has been proposed for a flexible connection between ROADMs. However, in Open ROADM, the use of the OSC for inter-node communication is not accepted. Therefore, in a WDM transmission system adopting Open ROADM, an optical safety control such as the automatic power shut down is realized using a LinkDown alarm in the Ethernet (registered trademark).

For example, in a similar manner as in the example illustrated in FIG. 1A, when the optical fiber that transmits the optical signal from the ROADM#1 to the ROADM#2 is disconnected from the input port of the ROADM#2, the ROADM#2 suspends the transmission of the WDM signal to the ROADM#1. In this case, as illustrated in FIG. 1B, negotiation (for example, AutoNegotiation) between the ROADM#1 and the ROADM#2 is not completed, and therefore, the LinkDown alarm is sent to the ROADM#1. Then, the ROADM#1 suspends the transmission of the WDM signal to the ROADM#2. As a result, the WDM signal is no longer output through the optical fiber.

Meanwhile, a method has been proposed for controlling an optical level for avoiding the possibility that the worker repairing a failure is irradiated with the WDM light (for example, Japanese Laid-open Patent Publication No. 2002-077056.

As described above, in a WDM transmission system adopting Open ROADM, an optical safety control is realized using negotiation (here, AutoNegotiation) between ROADMs. In this regard, new transmission schemes such as 1 GE support AutoNegotiation. However, existing communication schemes such as 100 ME does not necessarily support AutoNegotiation. For this reason, it may be impossible to perform the optical safety control such as the automatic power shut down (APSD) in the conventional WDM transmission system adopting Open ROADM.

### SUMMARY

According to an aspect of the present invention, an optical transmission system includes a first optical transmission device and a second optical transmission device that are connected to a network control device. The first optical transmission device and a second optical transmission device transmit a control signal and a main signal between them. The first optical transmission device suspends an optical output to the second optical transmission device and transmits a first report to the network control device when the first optical transmission device detects a loss of an optical signal. The second optical transmission device suspends an optical output to the first optical transmission device and transmits a second report to the network control device when the second optical transmission device detects a loss of an optical signal. The network control device transmits a first instruction to resume a transmission of the control signal to the first optical transmission device and the second optical transmission device when the network control device receives the first report and the second report. The network control device transmits a second instruction to resume a transmission of the main signal to the first optical transmission device and the second optical transmission device after the network control device receives reports that the first optical transmission device and the second optical transmission device respectively resume a transmission of the control signal respectively from the first optical transmission device and the second optical transmission device. The first optical transmission device and the second optical transmission device respectively resume a transmission of the control signal according to the first instruction received from the network control device, and respectively resume a transmission of the main signal according to the second instruction received from the network control device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B illustrate examples of the automatic power shut down according to the conventional technique;

FIG. 2 illustrates an example of an optical transmission system;

FIG. 3 illustrates an example of the arrangement of the WDM signal and the OSC signal.

FIGS. 4A, 4B, 4C, 4D, 5A, 5B and 5C illustrate examples of the automatic power shut down according to an embodiment of the present invention;

FIG. 6A illustrates an example of the transition between the states of a WDM transmission device;

FIG. 6B illustrates an example of the transition between the states of the network control device;

FIG. 7 illustrates an example of the configuration of a network control device and a WDM transmission device;

FIG. 8A illustrates an example of the hardware configuration of a controller that is provided in a network control device;

FIG. 8B illustrates an example of the hardware configuration of a controller that is provided in a WDM transmission device;

FIG. 9 is a flowchart illustrating fiber disconnection detection process;

FIG. 10 illustrates an example of the transition between the states of a WDM transmission device related to shut down;

FIG. 11 is a flowchart illustrating an example of a method for sending a report of the state of a WDM transmission device to a network control device;

FIG. 12 illustrates an example of the transition between the states of a network control device related to shut down;

FIG. 13 illustrates an example of functional blocks of a WDM transmission device and a network control device;

FIG. 14 is a flowchart illustrating a sequence for the time when fiber disconnection has occurred;

FIG. 15 is a flowchart illustrating a sequence for the time when an optical fiber has recovered; and

FIG. 16 illustrates an example of connection between WDM transmission devices and a network control device.

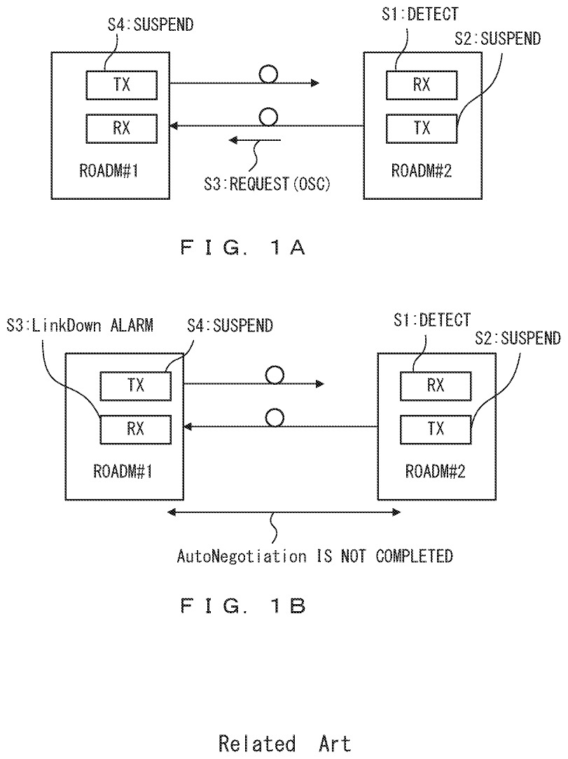

### DESCRIPTION OF EMBODIMENTS

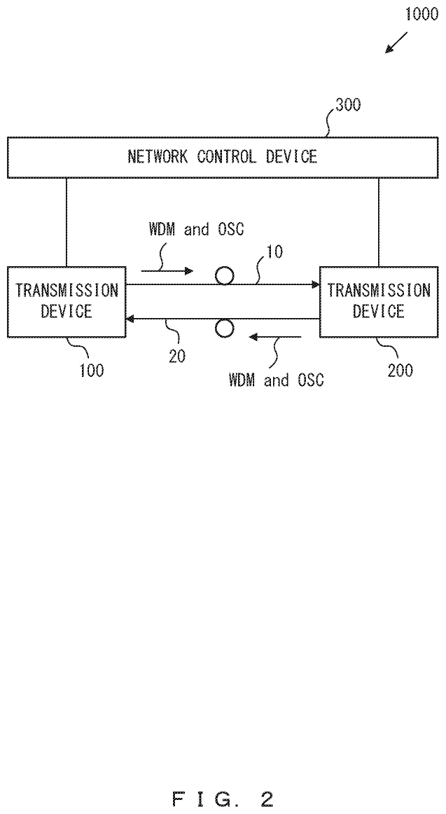

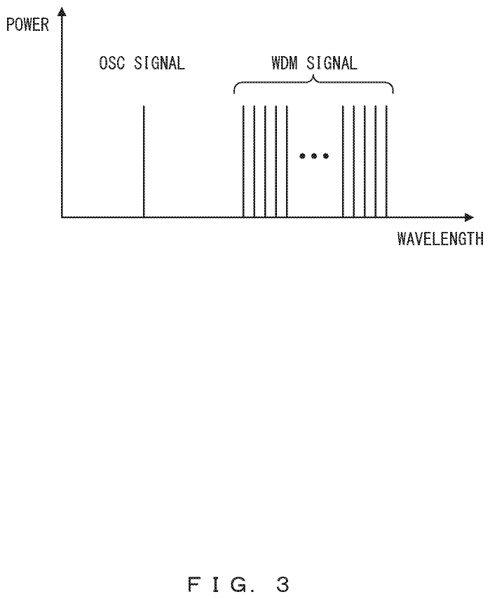

FIG. 2 illustrates an example of an optical transmission system according to an embodiment of the present invention. An optical transmission system 1000 according to an embodiment of the present invention includes a WDM transmission device 100, a WDM transmission device 200, and a network control device 300, as illustrated in FIG. 2. Meanwhile, in the example illustrated in FIG. 2, the optical transmission system 1000 is equipped with two WDM transmission devices (100, 200), but in practice, it may be equipped with three or more WDM transmission devices.

The WDM transmission devices 100 and 200 are respectively an example of an optical transmission device (for example, a ROADM) that transmits a WDM signal. Between the WDM transmission devices 100 and 200, an optical fiber 10 that propagates light from the WDM transmission device 100 to the WDM transmission device 200 and an optical fiber 20 that propagates light from the WDM transmission device 200 to the WDM transmission device 100 are provided. That is, the WDM transmission devices 100 and 200 are able to transmit the WDM signal bidirectionally between them. Meanwhile, the WDM signal is an example a main signal transmitted between the WDM transmission devices 100 and 200.

The WDM transmission device 100 may transmit an OSC signal to the WDM transmission device 200. In addition, the WDM transmission device 200 may transmit an OSC signal to the WDM transmission device 100. Meanwhile, the OSC signal is an example of a control signal that carries a supervisory signal and/or control information.

The WDM signal and the OSC signal are multiplexed and transmitted. Here, the OSC signal is arranged outside the signal band of the WDM signal. Therefore, the WDM transmission devices 100 and 200 are able to easily separate the WDM signal and the OSC signal using an optical filter.

The network control device 300 controls the WDM transmission devices 100 and 200. For example, the network control device 300 realizes the setting, deletion, change of wavelength paths by controlling the WDM transmission devices 100 and 200. In addition, the network control device 300 realizes an optical safety control for the WDM transmission devices 100 and 200 . In this example, the APSD: Automatic Power Shut Down is performed as the optical safety control. Meanwhile, the network control device 300 is realized by an SDN (Software Defined Network) controller, for example.

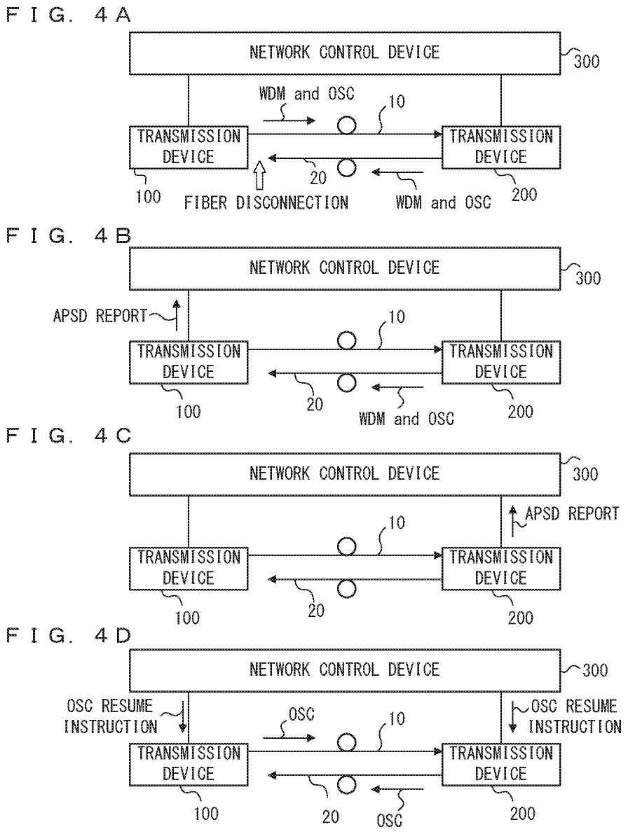

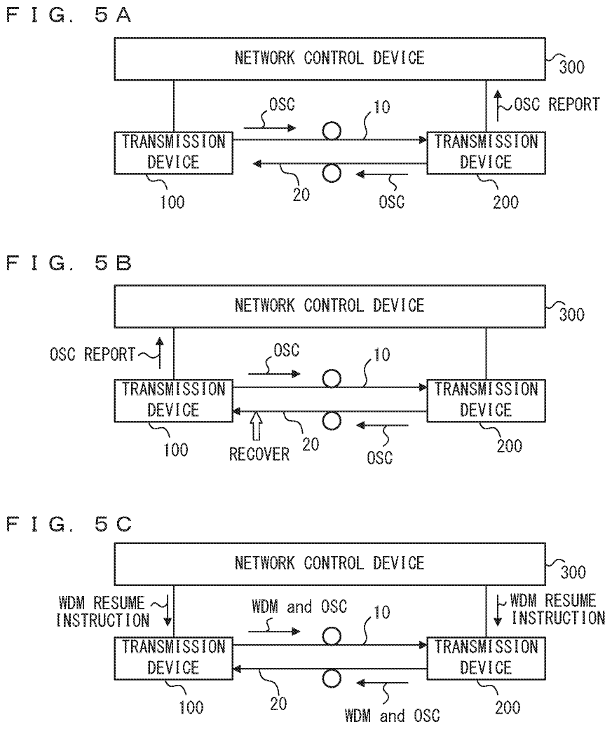

FIGS. 4A, 4B, 4C, 4D, 5A, 5B and 5C illustrate examples of the automatic power shut down according to an example of the present invention. The optical transmission system includes the WDM transmission device 100, the WDM transmission device 200, and the network control device 300, in a similar manner as in the example illustrated in FIG. 2. The WDM transmission device 100 transmits the WDM signal and the OSC signal to the WDM transmission device 200 via the optical fiber 10. The WDM transmission device 200 transmits the WDM signal and the OSC signal to the WDM transmission device 100 via the optical fiber 20.

As illustrated in FIG. 4A, it is assumed that the optical fiber 20 is disconnected from the input port of the WDM transmission device 100. In this case, the WDM signal and the OSC signal are output from the end of the optical fiber 20. In this example, a case in which the optical fiber is disconnected from the optical port of the WDM transmission device 100 is assumed, while the processes in FIG. 4A through FIG. 5C may also be applied to cases in which light does not reach the WDM transmission device 100 from the WDM transmission device 200 due to other factors. For example, the processes in FIG. 4A through FIG. 5C may also be applied to a case in which the optical fiber 20 is cut. In the description below, the state in which it is impossible to transmit light between the WDM transmission devices due to a failure of the optical fiber may be referred to as “fiber disconnection”.

When the optical fiber 20 is disconnected from the input port of the WDM transmission device 100, in the WDM transmission device 100, the receiving power of the WDM signal becomes lower than a specified threshold. It is preferable that the threshold is a value that is lower than the minimum receiving power of the optical signal transmitted via one wavelength channel, for example. Then, when the receiving power of the WDM signal becomes lower than the threshold, the WDM transmission device 100 suspends the transmission of the WDM signal and the OSC signal, as illustrated in FIG. 4B. At this time, the WDM transmission device 100 may determine that fiber disconnection has occurred. In addition, the WDM transmission device 100 transmits a report that represents the shutdown state (hereinafter, it may be referred to as an “APSD report”) to the network control device 300.

In this example, the transmission of the WDM signal and the OSC signal is suspended when the receiving power of the WDM signal is lower than a specified threshold, but the present invention is not limited to this procedure. For example, the WDM transmission device may suspend the transmission of the WDM signa and the OSC signal when the receiving power of the WDM signal is lower than the threshold and the OSC signal is not detected.

In addition, in the description below, the state in which the receiving power of the WDM signal is lower than the specified threshold in the WDM transmission device may be referred to as “a loss of an optical signal”. Alternatively, the state in which the receiving power of the WDM signal is lower than the specified threshold and the OSC signal is not detected, in the WDM transmission device, may be referred to as “a loss of an optical signal”.

When the WDM transmission device 100 suspends the transmission of the WDM signal and the OSC signal, the receiving power of the WDM signal in the WDM transmission device 200 becomes lower than the threshold. Then, when the receiving power of the WDM signal becomes lower than the threshold, the WDM transmission device 200 suspends the transmission of the WDM signal and the OSC signal, as illustrated in FIG. 4C. At this time, the WDM transmission device 200 may determine that fiber disconnection has occurred. In addition, the WDM transmission device 200 transmits an APSD report to the network control device 300.

Upon receiving the APSD report from both of the WDM transmission devices 100 and 200, the network control device 300 transmits an instruction for resuming the transmission of the OSC signal (hereinafter, it may be referred to as an “OSC resume instruction”) to the WDM transmission devices 100 and 200. Then, the WDM transmission device 100 transmits the OSC signal to the WDM transmission device 200, and the WDM transmission device 200 transmits the OSC signal to the WDM transmission device 100.

Note that when the WDM transmission device 200 resumes the transmission of the OSC signal, it means that the OSC signal is output from the end of the optical fiber 20. However, compared to the WDM signal, the optical power of the OSC signal is sufficiently low. Therefore, even when the OSC signal is output from the end of the optical fiber 20, it does not cause any problem.

The OSC signal transmitted from the WDM transmission device 100 is propagated via the optical fiber 10 and reaches the WDM transmission device 200. Upon receiving this OSC signal, the WDM transmission device 200 transmits a report that represents the reception of the OSC signal (hereinafter, it may be referred to as an “OSC report”) to the network control device 300, as illustrated in FIG. 5A. At this time, the WDM transmission device 200 may transmit the OSC report to the network control device 300 only when the OSC signal is received from the WDM transmission device 100 after the OSC resume instruction presented in FIG. 4D is received.

It is assumed that, after that, the optical fiber 20 is recovered. For example, the user or the network administrator connects the optical fiber 20 to the WDM transmission device 100. Then, the OSC signal transmitted from the WDM transmission device 200 reaches the WDM transmission device 100 via the optical fiber 20. Upon receiving the OSC signal, the WDM transmission device 100 transmits the OSC report to the network control device 300, as illustrated in FIG. 5B. At this time, the WDM transmission device may transmit the OSC report to the network control device 300 only when the OSC signal is received from the WDM transmission device 200 after the OSC resume instruction presented in FIG. 4D is received.

Upon receiving the OSC report from both of the WDM transmission devices 100 and 200, the network control device 300 transmits an instruction for resuming the transmission of the WDM signal (hereinafter, it may be referred to as a “WDM resume instruction”) to the WDM transmission devices 100 and 200, as illustrated in FIG. 5C. Then, the WDM transmission device 100 transmits the WDM signal to the WDM transmission device 200 according to the WDM resume instruction, and the WDM transmission device 200 transmits the WDM signal to the WDM transmission device 100 according to the WDM resume instruction.

As described above, when fiber disconnection occurs, both of the WDM transmission devices 100 and 200 suspend optical output. Next, according to the OSC resume instruction given by the network control device 300, the WDM transmission devices 100 and 200 respectively resume the transmission of the OSC signal. At this time, since the optical power of the OSC signal is sufficiently small, even if the OSC signal is output from the end of the optical fiber, it does not cause any problem.

After this, upon detecting the OSC signal, the WDM transmission devices 100 and 200 respectively transmit the OSC report to the network control device 300. Here, when the OSC report is received from both of the WDM transmission devices 100 and 200, the network control device 300 determines that the two optical fibers between the WDM transmission devices 100 and 200 are both normal and generates the WDM resume instruction. Then, according to the WDM resume instruction given by the network control device 300, the WDM transmission devices 100 and 200 respectively resumes the transmission of the WDM signal. Thus, when the optical fiber recovers, the normal transmission (that is, the communication in which the WDM signal and the OSC signal are transmitted) automatically recovers.

Meanwhile, in the APSD control illustrated in FIG. 4A through FIG. 5C, the network control device 300 determines whether or not the optical fiber has recovered according to the presence/absence of the OSC signal. In other words, the APSD control illustrated in FIG. 4A through FIG. 5C is realized without using the content of the OSC signal (that is, the information transmitted by the OSC signal). Therefore, this APSD control may also be applied to the WDM transmission system adopting Open ROADM.

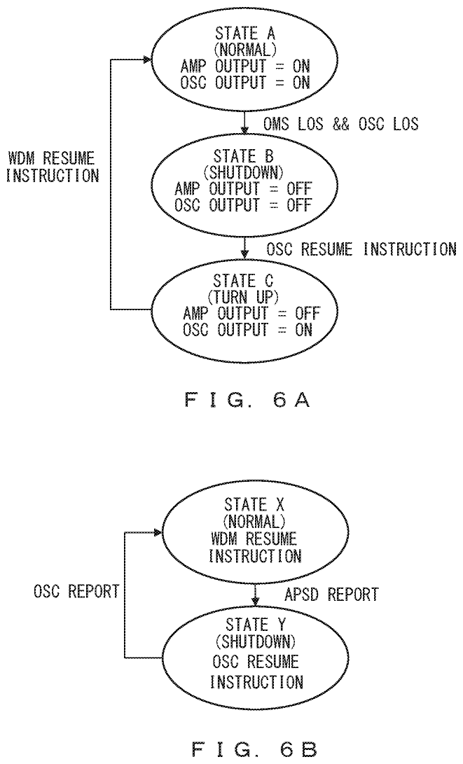

FIG. 6A illustrates an example of the transition between the states of the WDM transmission device. The state A (NORMAL) corresponds to the state in which the WDM transmission device is operating in a normal manner. That is, in the state A, the WDM transmission device outputs the WDM signal and the OSC signal. “AMP output” represents the state of the optical amplifier that amplifies the WDM signal. Then, when OMS_LOS and OSC_LOS are detected in the state A, the state of the WDM transmission device shifts to “B (SHUTDOWN)”. OMS_LOS represents the state in which the receiving optical power of the WDM signal band is lower than the threshold. OSC_LOS corresponds to the state in which the receiving optical power of OSC is lower than the threshold, or the state in which the OSC signal is not detected. In the state B, the WDM transmission device suspends the output of the WDM signal and the OSC signal.

When the OSC resume instruction is given by the network control device in the state B, the state of the WDM transmission device shifts to “C (TURN UP)”. In the state C, the WDM transmission device outputs the OSC signal but does not output the WDM signal. Further, when the WDM resume instruction is given by the network control device in the state C, the state of the WDM transmission device returns to “A”.

FIG. 6B illustrates an example of the transition between the states the network control device. In the state X (NORMAL), the network control device monitors the APSD report transmitted from the WDM transmission devices. Then, upon receiving the APSD report from both of the pair of the WDM transmission devices, the state of the network control device shifts to “Y (SHUTDOWN)”.

In the state Y, the network control device transmits the OSC resume instruction to both of the WDM transmission devices. In addition, the network control device monitors the OSC report transmitted from the WDM transmission device. Then, upon receiving the OSC report from both of the WDM transmission devices, the state of the network control device returns to “X”. Then, the network control device transmits the WDM resume instruction to both of the WDM transmission devices.

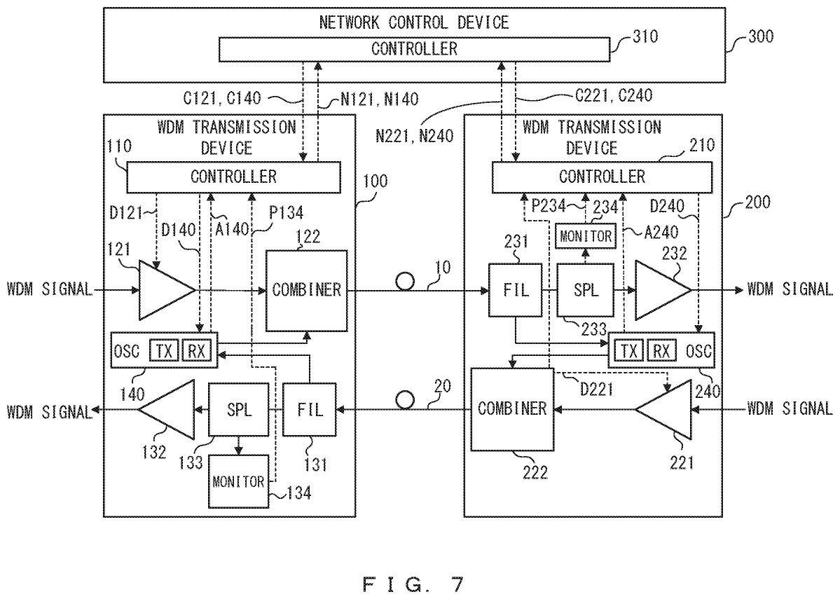

FIG. 7 illustrates an example of the configuration of the network control device and the WDM transmission device. The network control device 300 is equipped with a controller 310, as illustrated in FIG. 7. The controller 310 receives the report signals N121 and N140 from the WDM transmission device 100 and receives the report signals N221 and N240 from the WDM transmission device 200. In addition, the controller 310 generates control signals C121, C140, C221, and C240 according to the report signals N121, N140, N221, and N240. The control signals C121 and C140 are transmitted to the WDM transmission device 100, and the control signals C221 and C240 are transmitted to the WDM transmission device 200. Meanwhile, the network control device 300 may also be equipped with other functions or circuits not presented in FIG. 7. In addition, the report signals N121, N140, N221, and N240 and the control signals C121, C140, C221, and C240 are explained later.

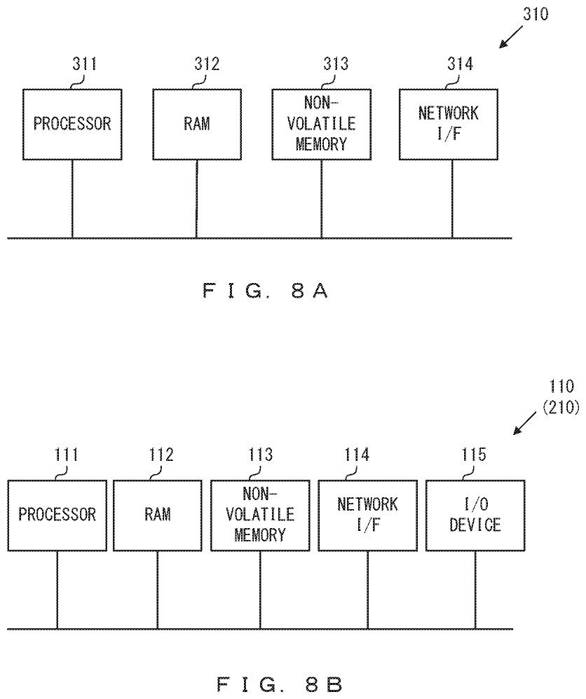

The controller 310 is realized by a processor 311, a RAM 312, a non-volatile memory 313, and a network interface 314, as illustrated in FIG. 8A. The processor 311 provides the functions of the network control device 300 by executing a control program stored in the non-volatile memory 313. The RAM 312 is used as the work area of the processor 311. In addition, the RAM 312 may also store data used by the network control device 300. The non-volatile memory 313 stores the control program executed by the processor 311. In addition, the non-volatile memory 313 may also store data used by the network control device 300. The network interface 314 provides an interface for the communication with other devices on the network (for example, the WDM transmission devices 100, 200).

The WDM transmission device 100 is equipped with a controller 110, an optical amplifier 121, a combiner 122, a WDM filter (FIL) 131, an optical amplifier 132, an optical splitter (SPL) 133, the optical monitor 134, the OSC transceiver 140, as illustrated in FIG. 7. Meanwhile, the WDM transmission device 100 may also be equipped with other functions or circuits not presented in FIG. 7.

The controller 110 receives the control signals C121 and C140 from the network control device 300, receives an alarm signal A140 from the OSC transceiver 140, and receives a power value signal P134 from the optical monitor 134. Then, the controller 110 generates the control signals D121 and D140 according to these signals. The D121 and D140 are given to the optical amplifier 121 and the OSC transceiver 140, respectively. Meanwhile, the alarm signal A140, the power value signal P134, and the control signals D121 and D140 are explained later.

The controller 110 is realized by a processor 111, a RAM 112, a non-volatile memory 113, a network interface 114, and an I/O device 115, as illustrated in FIG. 8B. The processor 111 provides the functions of the WDM transmission device 100 by executing a control program stored in the non-volatile memory 113. The RAM 112 is used as the work area of the processor 111. In addition, the RAM 112 may also store data used by the WDM transmission device 100. The non-volatile memory 113 stores the control program executed by the processor 111. In addition, the non-volatile memory 113 may also store data used by the WDM transmission device 100. The network interface 114 provides an interface for the communication with other devices on the network (for example, the network control device 300). The I/O device 115 includes a device that receives instructions of the network administrator, a device that displays the state of the WDM transmission device 100, and the like.

The optical amplifier 121 amplifies an input WDM signal. The gain of the optical amplifier 121 is controlled by the control signal D122 given by the controller 110. Meanwhile, the optical amplifier 121 is an example of a transmitter that transmits a WDM signal. The combiner 122 combines the WDM signal that is output from the optical amplifier 121 and the OSC signal that is generated by the OSC transceiver 140. Meanwhile, the combiner 122 may also be realized by a WDM filter. Then, the optical signal (the WDM signal and the OSC signal) that is output from the combiner 122 is transmitted to the WDM transmission device 200 via the optical fiber 10.

The WDM filter 131 extracts the WDM signal and the OSC light from the optical signal received via the optical fiber 20. The optical amplifier 132 amplifies the received WDM signal. The optical splitter 133 branches the received WDM signal and guides it to the optical monitor 134. The optical monitor 134 monitors the optical power of the received WDM signal. Then, the optical monitor 134 generates the power value signal P134 that represents the optical power of the received WDM signal. The power value signal P134 is sent to the controller 110.

The OSC transceiver 140 includes an OSC transmitter and an OSC receiver. The OSC transmitter generates and outputs an OSC signal. Meanwhile, the OSC transmitter is an example of a control signal transmitter that transmits a control signal. The OSC receiver receives the OSC light extracted by the WDM filter 131 from the received optical signal. Here, the OSC receiver is equipped with a function to monitor the power of the received OSC light and a function to determine whether or not the received OSC light transmits a specified OSC frame. That is, the OSC receiver is able to determine whether or not the WDM transmission device has received an OSC signal. Meanwhile, the OSC receiver is an example of a control signal monitor that monitors a control signal received from another WDM transmission device.

The OSC transceiver 140 may stop the OSC signal according to the control signal D140 given by the controller 110. In addition, the OSC transceiver 140 generates the alarm signal A140 that represents whether or not the OSC signal has been detected. The alarm signal A140 is transmitted to the controller 110.

The WDM transmission device 200 is equipped with a controller 210, an optical amplifier 221, a combiner 222, a WDM filter 231, an optical amplifier 232, an optical splitter 233, an optical monitor 234, an OSC transceiver 240, as illustrated in FIG. 7. The configuration and operations of the WDM transmission device 200 are substantially the same as those of the WDM transmission device 100, and therefore, explanation is omitted.

Fiber Disconnection Detection

In the description below, it is assumed that fiber disconnection detection is performed in the WDM transmission device 100. Here, the WDM transmission device 200 is able to perform a process that is virtually the same as that of the WDM transmission device 100. Note that the fiber disconnection detection is performed at specified time intervals, for example.

The OSC transceiver 140 monitors the OSC signal. Specifically, the OSC transceiver 140 compares the power of the OSC light guided from the WDM filter 131 with a specified threshold. Then, when the power of the OSC signal is lower than the threshold, the OSC transceiver 140 determines that the OSC signal does not reach the WDM transmission device 100 and updates the alarm signal A140 to “1”. Alternatively, the OSC transceiver 140 may demodulate the OSC signal and monitor whether or not an OSC frame of a specified format is detected. In this case, when the OSC frame is not detected, the alarm signal A140 is updated to “1”. Meanwhile, when the power of the OSC light is equal to or higher than the threshold (or when the OSC frame is detected), the alarm signal A140 is kept as “0”.

The optical monitor 134 monitors the optical power of the WDM signal. Then, the optical monitor 134 generates the power value signal P134 that represents the optical power of the received WDM signal.

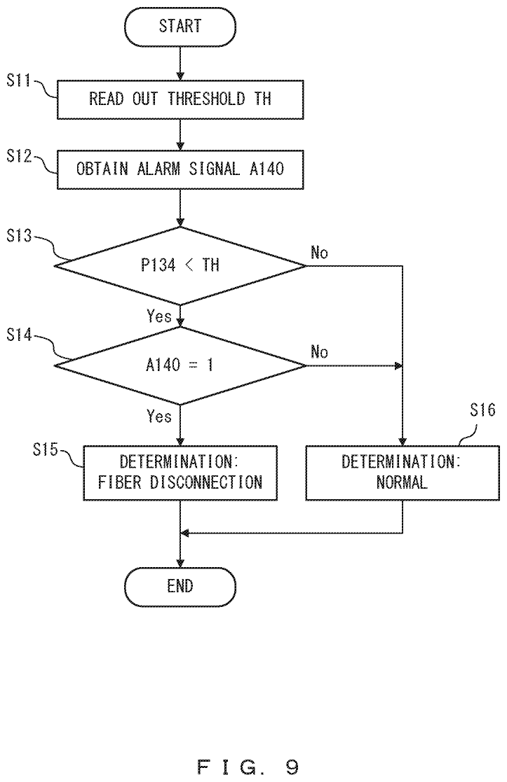

FIG. 9 s a flowchart illustrating an example of the fiber disconnection detection process. The flowchart is performed at specified intervals by the controller 110.

In S11, the controller 110 reads out a threshold TH from the memory in the controller 110. In S12, the controller 110 obtains the alarm signal A140 from the OSC transceiver 140. In S13, the controller 110 compare the power value signal P134 generated by the optical monitor 134 with the threshold TH. In S14, the controller 110 determines whether the alarm signal A140 is “1”. Then, when the power value signal P134 is lower than the threshold TH, and, the alarm signal A140 is “1”, the controller 110 determines that fiber disconnection has occurred, in S15. That is, when the optical power of the received WDM signal is lower than the threshold TH, and, the OSC signal is not detected, it is determined that fiber disconnection has occurred. Otherwise, the controller 110 determines that fiber disconnection has not occurred, in S16.

As described above, the fiber disconnection is detected according to the optical power of the WDM signal and the OSC signal. For this reason, even when the optical fiber is connected to the WDM transmission device, when the WDM transmission device provided in a correspondent node suspends the optical output, “fiber disconnection” is detected. Therefore, when the flowchart illustrated in FIG. 9 substantially determines whether or not the light has reached the input optical port of the WDM transmission device.

Shutdown

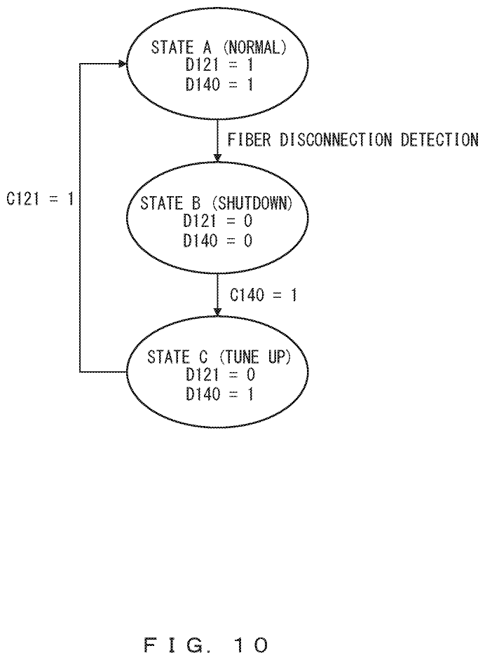

Referring to FIG. 7 and FIG. 10, the shutdown procedure and the shutdown cancel procedure are described. Here, it is assumed that the shutdown procedure and the shutdown cancel procedure are performed in the WDM transmission device 100. Here, the WDM transmission device 200 is able to perform a process that is substantially the same as that in the WDM transmission device 100.

The control signal C121 controls the transmission of the WDM signal. “C121=1” indicates the transmission of the WDM signal, and “C121=0” indicates the stop of the WDM signal.

The control signal C140 controls the transmission of the OSC signal. “C140=1” indicates the transmission of the OSC signal, and “C140=0” indicates the stop of the OSC signal.

The control signal D121 controls the transmission of the WDM signal in the WDM transmission device 100. “D121=1” indicates the transmission of the WDM signal, and “D121=0” indicates the stop of the WDM signal. The control signal D140 controls the transmission of the OSC signal in the WDM transmission device 100. “D140=1” indicates the transmission of the OSC signal, and “D140=0” indicates the stop of the OSC signal.

In the normal operation state (state A), the controller 110 outputs “1” as the control signal D121 and outputs “1” and the control signals D140. Then, the optical amplifier 121 amplifies the WDM signal and the OSC transceiver 140 generates the OSC signal. That is, the WDM transmission device 100 transmits the WDM signal and the OSC signal to the WDM transmission device 200.

When the fiber disconnection is detected, the operation state of the WDM transmission device 100 shifts from the normal operation state to the shutdown state (state B). In the shutdown state, the controller 110 outputs “0” as the control signal D121 and outputs “0” as the control signal D140. Then, the optical amplifier 121 suspends the output of the WDM signal, and the OSC transceiver 140 suspends the output of the OSC signal. That is, the WDM transmission device 100 suspends the transmission of the WDM signal and the OSC signal.

Upon receiving the control signal C140 (that is, C140=1) that instructs the restart of the OSC signal from the network control device 300, the operation state of the WDM transmission device 100 shifts from the shutdown state to the recovery waiting state (state C) . In the recovery waiting state, the controller 110 outputs “0” as the control signal D121 and outputs “1” as the control signal D140. Then, the OSC transceiver 140 resumes the transmission of the OSC signal. That is, the WDM transmission device 100 transmits the OSC signal. However, the WDM signal is not transmitted.

Upon receiving the control signal C121 (that is, C121=1) that instructs the resumption of the WDM signal from the network control device 300, the operation state of the WDM transmission device 100 shifts from the recovery waiting state to the normal operation state. That is, the WDM transmission device 100 transmits the WDM signal and the OSC signal.

State Report

In the description below, the WDM transmission device 100 sends a report of its own state to the network control device 300. Here, the WDM transmission device 200 is able to perform a process that is substantially the same as that of the WDM transmission device 100.

The report signal N121 represents the state of the optical amplifier 121. That is, the report signal N121 represents whether or not to transmit the WDM signal. The report signal N140 represents whether or not to transmit the OSC signal.

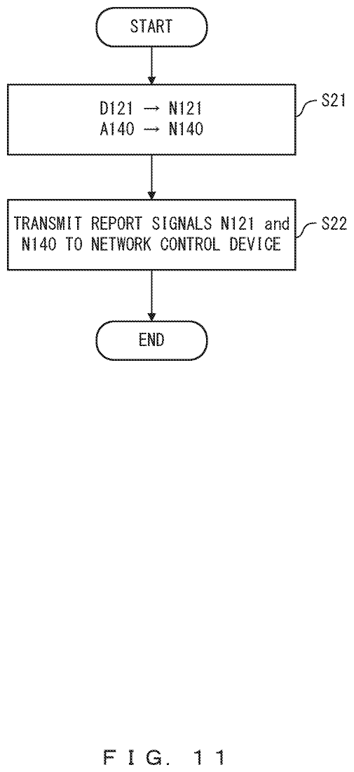

FIG. 11 is a flowchart illustrating an example of a method for sending a report of the state of the WDM transmission device to the network control device. In S21, the WDM transmission device 100 generates a report signal N121 and the report signal N140 according the control signal D121 and the alarm signal A140, respectively. Specifically, when the WDM signal is transmitted according to the control signal D121, the controller 110 sets the report signal N121 to “1”. When the WDM signal is stopped according to the control signal D121, the controller 110 sets the report signal N121 is “0”. In addition, the controller 110 determines whether or not the OSC signal is detected according to the alarm signal A140 generated by the OSC transceiver 140. Then, when the OSC transceiver 140 fails to detect the OSC signal, the controller 110 sets the report signal N140 to “1”. When the OSC transceiver 140 detects the OSC signal, the controller 110 sets the report signal N140 to “0”. Then, the controller 110 transmits the generated report signals N121 and N140 to the network control device 300 in S22.

Network Control Device

The network control device 300 receives the report signals N121 and N140 from the WDM transmission device 100 and receives the report signals N221 and 240 from the WDM transmission device 200. Then, the network control device 300 generates the control signals C121, 140, 221, and 240 according to these report signals.

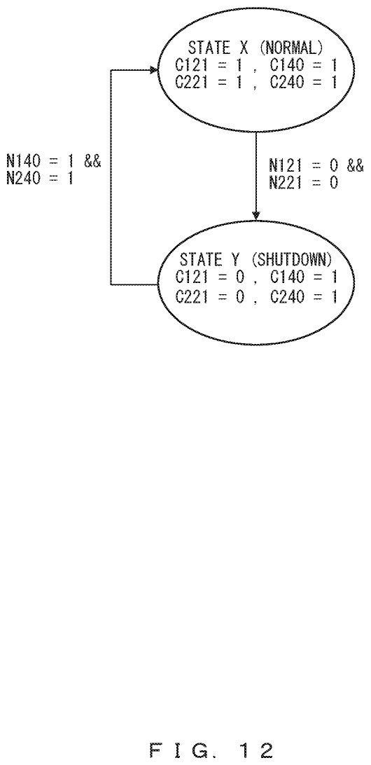

In the normal operation state (state X), as illustrated in FIG. 12, the controller 310 outputs “C121=1 (transmission of the WDM signal)”, “C140=1 (transmission of the OSC signal)”, “C221=1 (transmission of the WDM signal)”, “C240=1 (transmission of the OSC signal)”. Then, the WDM transmission device 100 transmits the WDM signal and the OSC signal according to the control signals C121 and C140. In a similar manner, the WDM transmission device 200 transmits the WDM signal and the OSC signal according to the control signals C221 and C240.

Upon receiving “N121=0 (stop of the WDM signal)” from the WDM transmission device 100, and, receiving “N221=0 (stop of the WDM signal)” from the WDM transmission device 200, the control state of the controller 310 shifts from the normal operation state to the shutdown state (state Y). In the shutdown state, the controller 310 outputs “C121=0 (stop of the WDM signal)”, “C140=1 (transmission of the OSC signal)”, “C221=0 (stop of the WDM signal)”, “C240=1 (transmission of the OSC signal)”. Then, the WDM transmission device 100 stops the WDM signal according to the control signal C121. In a similar manner, the WDM transmission device 200 stops the WDM signal according to the control signal C221. However, the WDM transmission devices 100 and 200 respectively transmits the OSC signal according to according to the control signal C140 and C240.

Upon receiving “N140=1 (reception of the OSC signal)” from the WDM transmission device 100, and, receiving N240=1 (reception of the OSC signal)” from the WDM transmission device 200, the control state of the controller 310 shifts from the shutdown state to the normal operation state.

### EXAMPLES

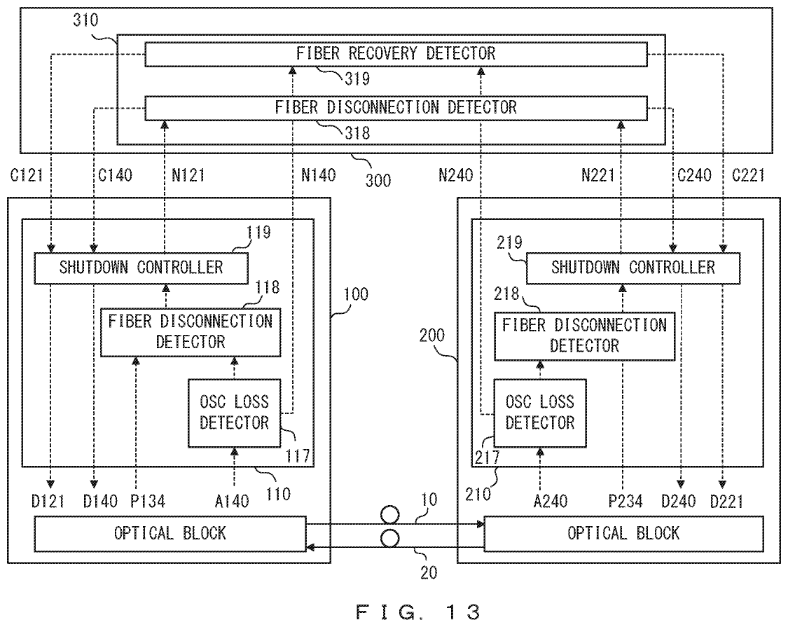

FIG. 13 illustrates an example of functional blocks of the WDM transmission device and the network control device. Note that the optical blocks illustrated in FIG. 13 corresponds to the optical amplifiers (121, 221), the combiner (122, 222), the WDM filters (131, 231), the optical amplifier (132, 232), the optical splitters (133, 233), the optical monitors (134, 234), and the OSC transceivers (140, 240) presented in FIG. 7.

In the WDM transmission device 100, the controller 110 includes an OSC loss detector 117, a fiber disconnection detector 118, and a shutdown controller 119. The OSC loss detector 117 determines whether or not OSC disconnection has occurred, according to the alarm signal A140 generated by the OSC transceiver 140. The OSC disconnection corresponds to the state in which the optical power of the OSC light is lower than a specified threshold, or the state in which the OSC frame is not detected. Then, the OSC loss detector 117 sends a report of the determination result to the fiber disconnection detector 118. In addition, this determination result is sent to the network control device 300 as the report signal N140.

The fiber disconnection detector 118 determines whether or not fiber disconnection has occurred, according to the power value signal A134 generated by the optical monitor 134 and the determination result by the OSC loss detector 117. The fiber disconnection is detected, as explained with reference to FIG. 9, when the optical power of the WDM signal is lower than the threshold and the OSC disconnection has occurred. Then, the fiber disconnection detector 118 sends a report of the determination result to the shutdown controller 119.

Upon receiving a signal that represents the occurrence of fiber disconnection from the fiber disconnection detector 118, the shutdown controller 119 suspends the output of the optical amplifier 121 using the control signal D121 and suspends the transmission of the OSC signal using the control signal D140. In addition, the shutdown controller 119 generates the control signal D121 that controls the optical amplifier 121, according to the control signal C121 given from the network control device 300. Further, the shutdown controller 119 generates the control signal D140 that controls the OSC transceiver 140, according to the control signal C140 given by the network control device 300.

In the WDM transmission device 200, a controller 210 includes an OSC loss detector 217, a fiber disconnection detector 218, and a shutdown controller 219. The functions of the OSC loss detector 217, the fiber disconnection detector 218, and the shutdown controller 219 are substantially the same as those of the OSC loss detector 117, the fiber disconnection detector 118, and the shutdown controller 119, respectively, and therefore, explanation is omitted.

In the network control device 300, a controller 310 includes a fiber disconnection detector 318 and a fiber recovery detector 319. The fiber disconnection detector 318 generates the control signals C140 and C240 according to the report signals N121 and N221. Specifically, the fiber disconnection detector 318 transmits the controls signals (C140, C240) that instructs the resumption of the transmission of the OSC signal to the WDM transmission devices 100 and 200 upon receiving the report signals (N121, N221) from both of the WDM transmission devices 100 and 200.

The fiber recovery detector 319 generates the control signals C121 and C221 according to the report signals N140 and N240. Specifically, the fiber recovery detector 319 transmits the control signals (C121, C221) that instructs the resumption of the transmission of the WDM signal to the WDM transmission devices 100 and 200, upon receiving the report signals (N140, N240) from both of the WDM transmission devices 100 and 200.

Meanwhile, the fiber disconnection detector 318 is an example of a first controller that transmits an instruction for resuming the transmission of the OSC signal as a control signal to the WDM transmission device 100 and the WDM transmission device 200. In addition, the fiber recovery detector 319 is an example of a second controller that transmits an instruction for resuming the transmission of the WDM signal as a main signal to the WDM transmission device 100 and the WDM transmission device 200.

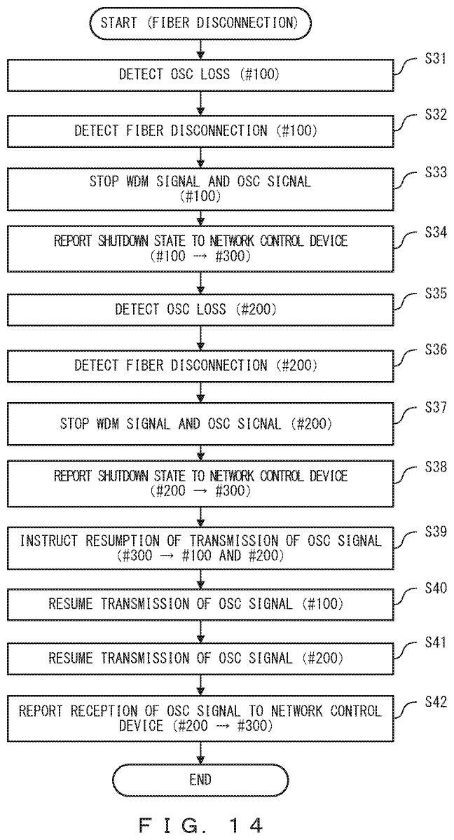

FIG. 14 is a flowchart illustrating a sequence for the time when fiber disconnection occurs. Here, it is assumed that the optical fiber 20 that transmits the optical signal from the WDM transmission device 200 to the WDM transmission device 100 is disconnected from the input port of the WDM transmission device 100. When the fiber disconnection of the optical fiber 20 occurs, the alarm signal A140 that indicates that the OSC signal is not detected is generated in the WDM transmission device 100.

S31: In the WDM transmission device 100, the OSC loss detector 117 detects that the OSC signal has not reached the WDM transmission device 100, according to the alarm signal A140. That is, the OSC loss detector 117 determines that OSC disconnection has occurred. A report of this determination result is sent to the fiber disconnection detector 118.

S32: In the WDM transmission device 100, the fiber disconnection detector 118 determines whether or not fiber disconnection has occurred, according to the power value signal A134 generated by the optical monitor 134 and the determination result by the OSC loss detector 117. In this example, the optical power of the WDM signal is lower than the threshold TH and OSC disconnection has occurred. In this case, the fiber disconnection detector 118 determines that the fiber disconnection of the optical fiber 20 has occurred. A report of this determination result is sent to the shutdown controller 119.

S33: In the WDM transmission device 100, upon receiving the determination result that indicates that the fiber disconnection of the optical fiber 20 has occurred, the shutdown controller 119 stops the WDM signal and the OSC signal. Specifically, the shutdown controller 119 suspends the transmission of the WDM signal by stopping the output of the optical amplifier 121 using the control signal D121. In addition, the shutdown controller 119 suspends the transmission of the OSC signal by giving an instruction to the OSC transceiver 140 using the control signal D140.

S34: In the WDM transmission device 100, the shutdown controller 119 sends a report to the network control device 300 that the WDM transmission device 100 has shifted to the shutdown state, using the report signal N121. After that, the controller 110 waits for the instruction given by the network control device 300.

As described, in S31-S34, the WDM transmission device 100 suspends the transmission of the WDM signal and the OSC signal. Therefore, the WDM transmission device 200 cannot receive the WDM signal and the OSC signal from the WDM transmission device 100. That is, for the WDM transmission device 200, the shutdown of the WDM transmission device 100 is equivalent to the fiber disconnection of the optical fiber 10. Therefore, the transmission device 200 performs, in S35-S38, processes that are equivalent to S31-S34.

S35: In the WDM transmission device 200, the OSC loss detector 217 detects that the OSC signal has not reached the WDM transmission device 200, according to the alarm signal A240. Therefore, the OSC loss detector 217 determines that OSC disconnection has occurred. A report of this determination result is sent to the fiber disconnection detector 218.

S36: In the WDM transmission device 200, the fiber disconnection detector 218 determines whether or not fiber disconnection has occurred, according to the power value signal A234 generated by the optical monitor 234 and the determination result by the OSC loss detector 217. In this example, the optical power of the WDM signal is lower than the threshold TH and OSC disconnection has occurred. In this case, the fiber disconnection detector 218 determines that the fiber disconnection of the optical fiber 10 has occurred. A report of this determination result is sent to the shutdown controller 219.

S37: In the WDM transmission device 200, upon receiving the determination result that indicates that the fiber disconnection of the optical fiber 10 has occurred, the shutdown controller 219 stops the WDM signal and the OSC signal. Specifically, the shutdown controller 219 suspends the transmission of the WDM signal by suspending the output of the optical amplifier 221 using the control signal D221. In addition, the shutdown controller 219 suspends the transmission of the OSC signal by giving an instruction to the OSC transceiver 240 using the control signal D240.

S38: In the WDM transmission device 200, the shutdown controller 219 sends a report to the network control device 300 that the WDM transmission device 200 has shifted to the shutdown state, using the report signal N221. After that, the controller 210 waits for the instruction given by the network control device 300.

S39: In the network control device 300, the fiber disconnection detector 318 generates the control signals C140 and C240 according to the report signal N121 received from the WDM transmission device 100 the report signals N221 received from the WDM transmission device 200. In this example, the report signals indicating the shutdown state is received from both of the WDM transmission devices 100 and 200, and therefore, the fiber disconnection detector 318 sends the control signals C140 and C240 that instruct the resumption of the transmission of the OSC signal to the WDM transmission devices 100 and 200, respectively.

S40: In the WDM transmission device 100, the shutdown controller 119 receives the control signal C140 from the network control device 300 that instructs the resumption of the transmission of the OSC signal. Then, using the control signal D140, the shutdown controller 119 makes the OSC transceiver 140 transmit the OSC signal. Accordingly, the WDM transmission device 100 transmits the OSC signal to the WDM transmission device 200.

S41: In the WDM transmission device 200, the shutdown controller 219 receives the control signal C240 from the network control device 300 that instructs the resumption of the transmission of the OSC signal. Then, using the control signal D240, the shutdown controller 119 makes the OSC transceiver 240 transmit the OSC signal. Accordingly, the WDM transmission device 200 transmits the OSC signal to the WDM transmission device 100.

Here, the WDM transmission device 200 receives the OSC signal transmitted from the WDM transmission device 100. In the WDM transmission device 200, this OSC signal is guided to the OSC transceiver 240. Then, the OSC transceiver 240 changes the alarm signal A240 from “1 (OSC absent)” to “0 (OSC present)”.

S42: In the WDM transmission device 200, the OSC loss detector 217 detects that the WDM transmission device 200 has received the OSC signal, according to the alarm signal A240. That is, the OSC loss detector 217 determines that the OSC has recovered. Then, the OSC loss detector transmits the report signal N240 that represents this determination result to the network control device 300.

Meanwhile, as described above, the WDM transmission device 200 transmits the OSC signal to the WDM transmission device 100 in S41. However, at this point in time, the optical fiber 20 has not recovered yet. For this reason, the WDM transmission device 100 cannot receive the OSC signal transmitted from the WDM transmission device 200. Therefore, in the WDM transmission device 100, the alarm signal A240 is unchanged from “1 (OSC signal absent)”.

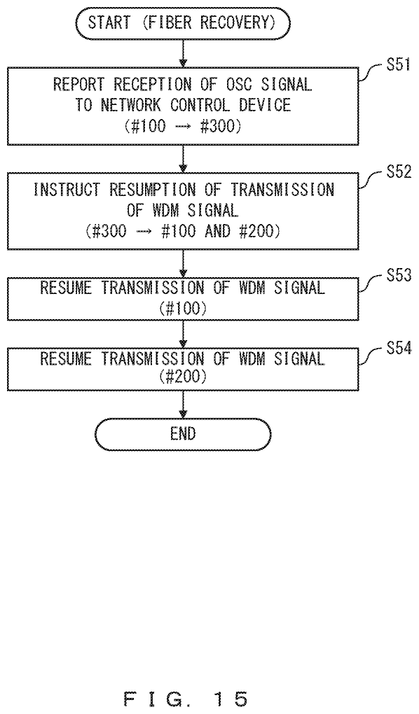

FIG. 15 is a flowchart illustrating a sequence for the time when the optical fiber has recovered. Here, it is assumed that the sequence is performed after the sequence illustrated in FIG. 14. That is, the WDM transmission devices 100 and 200 has respectively received the OSC signal but is not transmitting the WDM signal. Then, it is assumed that the user or the network administrator restores the optical fiber 20 by manual work.

When the optical fiber 20 recovers, the WDM transmission device 100 receives the OSC signal transmitted from the WDM transmission device 200. In the WDM transmission device 100, the OSC signal is guided to the OSC transceiver 140. Then, the OSC transceiver 140 changes the alarm signal A240 from “1 (OSC signal absent)” to “0 (OSC signal present)”.

S51: In the WDM transmission device 100, the OSC loss detector 117 detects that the WDM transmission device 100 received the OSC signal, according to the alarm signal A140. That is, the OSC loss detector 117 determines that the OSC has recovered. Then, the OSC loss detector 117 transmits the report signal N140 that represents this determination result to the network control device 300.

S52: In the network control device 300, the fiber recovery detector 319 generates the control signals C121 and C221 according to the report signal N140 received from the WDM transmission device 100 and the report signal S240 received from the WDM transmission device 200. In this example, the report signals representing the reception of the OSC signal are received from both of the WDM transmission devices 100 and 200, and therefore, the fiber recovery detector 319 transmits the control signals C121 and C221 that instruct the resumption of the transmission of the WDM signal to the WDM transmission devices 100 and 200, respectively.

S53: In the WDM transmission device 100, the shutdown controller 119 receives the control signal C121 that instructs the resumption of the transmission of the WDM signal from the network control device 300. Then, using the control signal D121, the shutdown controller 119 makes the optical amplifier 121 output the WDM signal. Accordingly, the WDM transmission device 100 transmits the WDM signal the WDM transmission device 200.

S54: In the WDM transmission device 200, the shutdown controller 119 receives the control signal C221 that instructs the resumption of the transmission of the WDM signal from the network control device 300. Then, using the control signal D221, the shutdown controller 219 makes the optical amplifier 221 output the WDM signal. Accordingly, the WDM transmission device 200 transmits the WDM signal the WDM transmission device 100.

As described above, when the optical fiber between the WDM transmission devices 100 and 200 recovers, the transmission of the WDM signal between the WDM transmission devices 100 and 200 resumes automatically. At this time, optical safety control including automatic power shutdown and automatic power shutdown cancel control is realized without using the content of the OSC signal (that is, information transmitted by the OSC signal). Therefore, it is possible to apply this optical safety control to a WDM transmission system adopting Open ROADM.

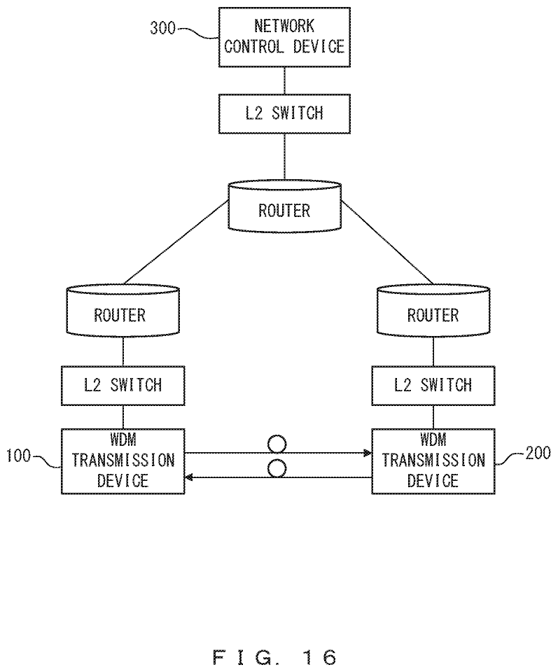

FIG. 16 illustrates an example of the connection between the WDM transmission devices 100, 200 and the network control device 300. In this example, the WDM transmission device 100 is connected to the network control device 300 via an L2 switch and a router. In addition, the WDM transmission device 200 is also connected to the network control device 300 via an L2 switch and a router. In a similar manner, the network control device 300 is connected to the respective WDM transmission devices (that is, the WDM transmission devices 100, 200) via an L2 switch and a router.

The WDM transmission device 100 and the L2 switch, the WDM transmission device 200 and the L2 switch, and the network control device 300 and the L2 switch are respectively connected by a LAN cable or an optical fiber. The L2 switches and the routers are respectively connected by a LAN cable or an optical fiber. The connections between routers are respectively realized by a LAN cable or an optical fiber.

The WDM transmission devices 100 and 200 may be connected by one or more optical fibers. Meanwhile, the WDM transmission devices 100 and 200 may be connected by a first optical fiber that transmits an optical signal from the WDM transmission device 100 to the WDM transmission device 200 and a second fiber that transmits an optical signa from the WDM transmission device 200 to the WDM transmission device 100. Alternatively, the WDM transmission devices 100 and 200 may be connected by an optical fiber that bidirectionally transmits an optical signal between the WDM transmission device 100 and the WDM transmission device 200.

The WDM transmission devices 100 and 200 may transmit an optical signal using the C band or the L band. In the case in which the C band is used, for example, the wavelength of the OSC signal as the control signal is 1511 nm, and the wavelength band of the WDM signal as the main signal is 1528.77-1566.72 nm. Meanwhile, in the case in which the L band is used, for example, the wavelength of the OSC signal is 1531 nm, and the wavelength band of the WDM signal is 1570.42-1610.49 nm. The signal rate of the OSC signal is, for example, 100 Mbps, 155 Mbps, or 1 Gbps. Meanwhile, the signal rate of the WDM signal is, for example, 100 Gbps or 200 Gbps.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An optical transmission system including a first optical transmission device and a second optical transmission device that are connected to a network control device and that transmit a control signal and a main signal between the first optical transmission device and the second optical transmission device, wherein
the first optical transmission device suspends an optical output to the second optical transmission device and transmits a first report to the network control device when the first optical transmission device detects a loss of an optical signal;
the second optical transmission device suspends an optical output to the first optical transmission device and transmits a second report to the network control device when the second optical transmission device detects a loss of an optical signal;
the network control device transmits a first instruction to resume a transmission of the control signal to the first optical transmission device and the second optical transmission device when the network control device receives the first report and the second report;
the network control device transmits a second instruction to resume a transmission of the main signal to the first optical transmission device and the second optical transmission device after the network control device receives reports that the first optical transmission device and the second optical transmission device respectively resume a transmission of the control signal respectively from the first optical transmission device and the second optical transmission device; and
the first optical transmission device and the second optical transmission device respectively resume a transmission of the control signal according to the first instruction received from the network control device, and respectively resume a transmission of the main signal according to the second instruction received from the network control device.

2. The optical transmission system according to claim 1, wherein
the control signal is arranged outside a wavelength band of the main signal.

3. The optical transmission system according to claim 1, wherein
the first optical transmission device includes
a first transmitter that transmits a first main signal;
a first control signal transmitter that transmits a first control signal;
a first optical monitor that monitors a power of a main signal received from the second optical transmission device;
a first control signal monitor that monitors a control signal received from the second optical transmission device; and
a first controller that controls the first transmitter and the first control signal transmitter,
the second optical transmission device includes
a second transmitter that transmits a second main signal;
a second control signal transmitter that transmits a second control signal;
a second optical monitor that monitors a power of a main signal received from the first optical transmission device;
a second control signal monitor that monitors a control signal received from the first optical transmission device; and
a second controller that controls the second transmitter and the second control signal transmitter, wherein
between the first optical transmission device and the second optical transmission device, a first optical fiber that transmits the first main signal and the first control signal from the first optical transmission device to the second optical transmission device and a second optical fiber that transmits the second main signal and the second control signal from the second optical transmission device to the first optical transmission device are provided;
when an optical power of the second main signal monitored by the first optical monitor is lower than a specified threshold and the second control signal is not detected by the first control signal monitor, the first transmitter suspends a transmission of the first main signal, the first control signal transmitter suspends a transmission of the first control signal, and the first controller transmits the first report to the network control device;
when an optical power of the first main signal monitored by the second optical monitor is lower than a specified threshold and the first control signal is not detected by the second control signal monitor, the second transmitter suspends a transmission of the second main signal, the second control signal transmitter suspends a transmission of the second control signal, and the second controller transmits the second report to the network control device;
when the network control device receives the first report and the second report, the network control device transmits the first instruction to the first optical transmission device and the second optical transmission device;
when the first optical transmission device receives the first instruction, the first control signal transmitter resumes the transmission of the first control signal;
when the second optical transmission device receives the first instruction, the second control signal transmitter resumes the transmission of the first control signal;
when the first control signal monitor detects the second control signal, the first controller transmits a third report to the network control device;
when the second control signal monitor detects the first control signal, the second controller transmits a fourth report to the network control device;
when the network control device receives the third report and fourth report, the network control device transmits the second instruction to the first optical transmission device and the second optical transmission device;
when the first optical transmission device receives the second instruction, the first transmitter resumes the transmission of the first main signal; and
when the second optical transmission device receives the second instruction, the second transmitter resumes the transmission of the second main signal.

4. The optical transmission system according to claim 3, wherein
when, due to a failure of the second optical fiber, a power of the second main signal monitored by the first optical monitor becomes lower than the specified threshold and the second control signal is no longer detected by the first optical monitor, the first transmitter suspends the transmission of the first main signal, the first control signal transmitter suspends the transmission of the first control signal, and the first controller transmits the first report to the network control device.

5. A network control device connected to a first optical transmission device and a second optical transmission device that transmit a control signal and a main signal between the first optical transmission device and the second optical transmission device, comprising:
a first controller that transmits a first instruction to resume a transmission of a control signal to the first optical transmission device and the second optical transmission device when the network control device receives a first report from the first optical transmission device and a second report from the second optical transmission device, the first report being generated by the first optical transmission device when the first optical transmission device detects a loss of an optical signal transmitted from the second optical transmission device to the first optical transmission device, the second report being generated by the second optical transmission device when the second optical transmission device detects a loss of an optical signal transmitted from the first optical transmission device to the second optical transmission device; and
a second controller that transmits a second instruction to resume a transmission of a main signal to the first optical transmission device and the second optical transmission device when the network control device receives a third report from the first optical transmission device and a fourth report from the second optical transmission device after the first controller transmits the first instruction to the first optical transmission device and the second optical transmission device, the third report being generated by the first optical transmission device when the first optical transmission device receives a control signal from the second optical transmission device, the fourth report being generated by the second optical transmission device when the second optical transmission device receives a control signal from the first optical transmission device.

6. An optical transmission device that transmits and receives an optical signal to and from a correspondent optical transmission device, the optical transmission device comprising:
a transmitter that transmits a main signal;
a control signal transmitter that transmits a control signal;
a monitor that monitors an optical signal transmitted from the correspondent optical transmission device; and
a controller that controls the transmitter and the control signal transmitter, wherein
when the monitor detects a loss of an optical signal, the transmitter suspends a transmission of the main signal, the control signal transmitter suspends a transmission of the control signal, and the controller transmits a shutdown report that indicates a suspension of an optical input to the network control device;
when the optical transmission device receives a first instruction from the network control device, the control signal transmitter resumes the transmission of the control signal, the first instruction being generated by the network control device
when the network control device receives the shutdown report from both of the optical transmission device and the correspondent optical transmission device;
when the monitor detects a control signal transmitted from the correspondent optical transmission device, the controller transmits a detection report that indicates a detection of a control signal to the network control device; and
when the optical transmission device receives a second instruction from a network control device, the transmitter resumes the transmission of the main signal, the second instruction being generated by the network control device when the network control device receives the detection report from both of the optical transmission device and the correspondent optical transmission device.

7. An optical transmission method for transmitting a WDM signal in an optical transmission system comprising a first optical transmission device, a second optical transmission device, and a network control device that controls the first optical transmission device and the second optical transmission device, wherein
the first optical transmission device includes a first transmitter that transmits a first WDM signal and a first control signal transmitter that transmits a first control signal;
the second optical transmission device includes a second transmitter that transmits a second WDM signal and a second control signal transmitter that transmits a first control signal;
between the first optical transmission device and the second optical transmission device, a first optical fiber that transmits the first WDM signal and the first control signal from the first optical transmission device to the second optical transmission device and a second optical fiber that transmits the second WDM signal and the second control signal from the second optical transmission device to the first optical transmission device are provided;
when an optical power of the second WDM signal is lower than a specified threshold and the second control signal is not detected in the first optical transmission device, the first optical transmission device suspends a transmission of the first WDM signal and the first control signal and transmits a first report to the network control device;
when an optical power of the first WDM signal is lower than a specified threshold and the first control signal is not detected in the second transmission device, the second optical transmission device suspends a transmission of the second WDM signal and the second control signal and transmits a second report to the network control device;
when the network control device receives the first report and the second report, the network control device transmits a first instruction to the first optical transmission device and transmits a second instruction to the second optical transmission device;
when the first optical transmission device receives the first instruction, the first optical transmission device resumes a transmission of the first control signal;
when the second optical transmission device receives the second instruction, the second optical transmission device resumes a transmission of the first control signal;
when the second control signal is detected in the first optical transmission device, the first optical transmission device transmits a third report to the network control device;
when the first control signal is detected in the second optical transmission device, the second optical transmission device transmits a fourth report to the network control device;
when the network control device receives the third report and fourth report, the network control device transmits a third instruction to the first optical transmission device and transmits a fourth instruction to the second optical transmission device;
when the first optical transmission device receives the third instruction, the first optical transmission device resumes the transmission of the first WDM signal; and
when the second optical transmission device receives the fourth instruction, the second optical transmission device resumes the transmission of the second WDM signal.
